(19) United States
(12) Patent Application Publication
(10) Pub. No.: US 2009/0044867 A1
(43) Pub. Date: Feb. 19, 2009

(54) Mechanism for facilitating cleaning of filter of steam trap without shutting down boiler

(76) Inventor: Ying Chuan Chiang, Taichung (TW)

Correspondence Address: SAM CHEN, 7F-1, 293, ROOSEVELT ROAD, SEC 3, TAIPEI, TW

(21) Appl. No.: 11/838,702

(22) Filed: Aug. 14, 2007

(51) Int. Cl. F16T 1/38

(52) U.S. Cl. 137/182

(57) ABSTRACT

A mechanism is adapted to clean a filter of a steam trap by opening a valve at one end of the filter by turning an adjusting screw secured to one end of the valve without shutting down a boiler in which a flow path is formed from one end of the filter to a drain via the valve and the adjusting screw after the valve opening. A stop projects into the valve for preventing the adjusting screw from disengaging the valve by stopping an annular flange of a valve cone in the valve opening operation.

### BACKGROUND OF THE INVENTION

1. Field of Invention

The invention relates to filters and more particularly to a mechanism for facilitating cleaning of the filter of a steam trap without shutting down boiler.

2. Description of Related Art

Conventionally, a steam trap is used to remove water and gases from a steam pipe while preventing the escape of live steam. And if, for example, the condensate is not removed, it will accumulate at low spots and present flow impediments and other inefficiencies.

A conventional orifice-type steam trap is shown in FIG. 5 and comprises a cylindrical housing 80 having an inlet 81 at one end and an outlet 82 at the other end. Within the housing 80 there are provided a narrow fluid path 83, an enlarged first space 84 adjacent the inlet 81, and an enlarged second space 85 adjacent the outlet 82. That is, the inner space of the housing 80 has a shoulder cross-section. Within the second space 85 there are mounted two funnel-like first members 86 and a funnel-like second member 87 fitted together. Either first member (e.g., the front first member 86) has a truncated conic head 88 and a narrow fluid path 83 through its center. The front first member 86 has its head 88 projecting into the first space 84. A cavity (e.g., the front cavity 89) is formed between the front first member 86 and the intermediate first member 86 and another cavity (not numbered) is formed between the intermediate first member 86 and the rear second member 87 respectively. The second member 87 has a rearward extending fastening portion and a narrow fluid path 91 through its center. By utilizing this staged arrangement, it is possible of without losing steam from the steam trap. Moreover, part replacement is made easy.

A Y-strainer fitting 92 is provided and has a first end secured to the inlet 81, a second end secured to a live steam pipe (not numbered), and an inclined housing 93. Within the housing 93, there are provided a cylindrical filter 94 having a screen 95 with a plurality of very small apertures 96 thereon. A plug 97 is threadedly secured to a third end of the Y-strainer fitting 92. The filter 94 is adapted to separate particulate matter and also provide a collection locus for water droplets.

However, the well known filter 94 suffers from several disadvantages. For example, an inlet of the filter 94 is secured to a baffle (not numbered) on an inner surface of the Y-strainer fitting 92 and an outlet thereof is secured to the plug 97. It is typical for an employee to loosen the plug 97 and then remove the filter 94 after a regular period of time of operation. The cleaning is always done after shutting down the boiler and sufficiently cooling same. Otherwise, the employee may be hurt by the hot steam remained in the steam pipe. Unfortunately, filter cleaning after shutting down boiler is not effective and the cleaning is relatively time consuming. Thus, the need for improvement still exists.

### SUMMARY OF THE INVENTION

It is therefore one object of the invention to provide a thread based mechanism for cleaning of a filter of a steam trap by opening a valve at one end of the filter without shutting down a boiler.

The above and other objects, features and advantages of the invention will become apparent from the following detailed description taken with the accompanying drawings.

### BRIEF DESCRIPTION OF THE DRAWINGS

FIG. 1 is an exploded perspective view of a steam trap incorporating a mechanism for facilitating cleaning of its filter according to the invention;

FIG. 2 is a perspective view of the assembled steam trap;

FIG. 3 is a sectional view of the steam trap shown in FIG. 2 where the inlet port of the valve is closed;

FIG. 4 is a view similar to FIG. 3 where the inlet port is open by loosening the adjusting member; and

FIG. 5 is a sectional view of a conventional orifice-type steam trap.

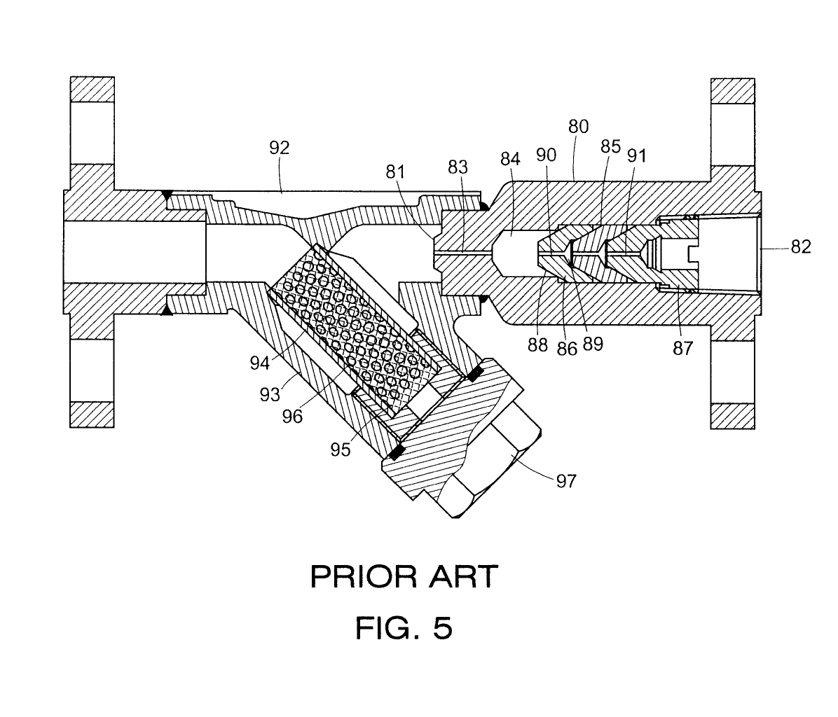

### DETAILED DESCRIPTION OF THE INVENTION

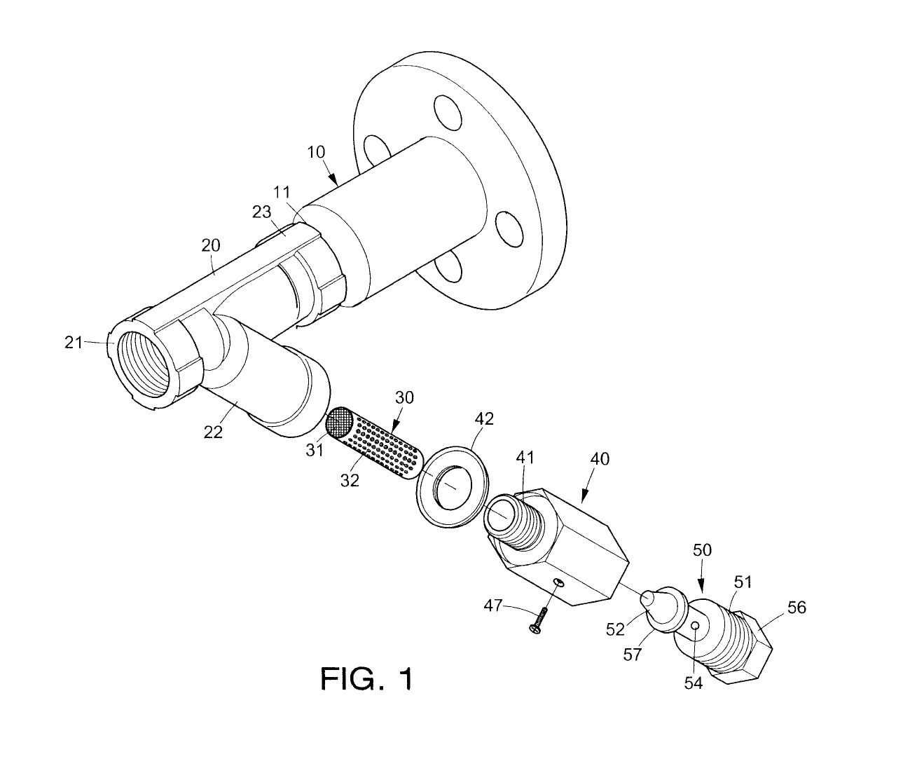

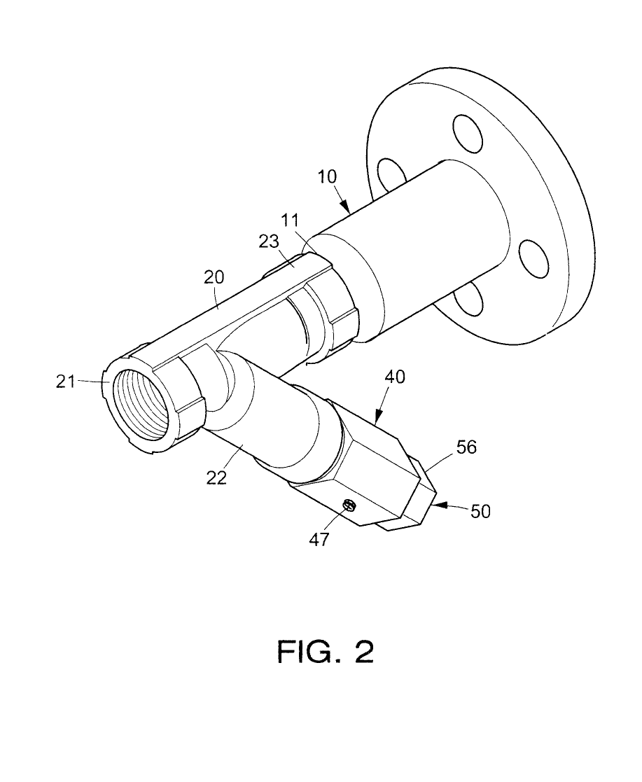

Referring to FIGS. 1 to 4, a preferred embodiment of the invention comprises a steam trap 10, a Y-strainer fitting 20, a filter 30 in the Y-strainer fitting 20, a valve 40 at a third end of the Y-strainer fitting 20, and an adjusting member 50 at one end of the valve 40 opposing the filter 30. Each component is discussed in detail below.

The Y-strainer fitting 20 has a first end 23 secured to an inlet 11 of the steam trap 10, a second end 21 threadedly secured to a steam pipe (not numbered), and an inclined housing 22 projecting from the straight portion of the Y-strainer fitting 20. The housing 93 is adapted to accommodate the cylindrical filter 30 which is adapted to separate particulate matter and also provide a collection locus for water droplets as known in the art. In operation, live steam coming from the steam pipe leaves the first end 23 after passing the filter 30. Finally, the steam enters the steam trap 10.

Condensate is generated due to condensation of the steam. Finally, the condensate is removed through the outlet 12 of the steam trap 10. Also, dry steam returns to the steam pipe. The condensate removal function of the steam trap is well known in the art and a detailed description thereof is therefore deemed unnecessary.

The filter 30 has both ends open and is formed of fibrous material (e.g., fibrous pad 31). A cylindrical wire screen with the fibrous pad 31 contained therein has a plurality of very small apertures 32 formed on its surface. One end (i.e., inlet opening) of the filter 30 is secured to a baffle 24 on an inner surface of the Y-strainer fitting 20 and the other end (i.e., an outlet opening) thereof is secured to the valve 40.

The valve 40 comprises a ring shaped seal 42, an externally threaded extension 41 at the other end, the extension 41 being adapted to secure to inner threads at one end of the housing 22 with the seal 42 being fastened therebetween, an inlet port 43 having a flared mouth, a chamber 44 in communication with the inlet port 43, a shoulder 45 in front of the inlet port 43 with the other end of the filter 30 anchored thereon, inner threads 46 formed on a rear portion of the chamber 44, and a screw 47 driven into the chamber 44 from an outer surface of the valve 40, the screw 47 being served as a stop as detailed later.

The hollow adjusting member 50 comprises an intermediate section 51 having outer threads, the intermediate section 51 being adapted to secure to the inner threads 46 for securing the adjusting member 50 and the valve 40 together, a forward cone 52 adapted to open or close the inlet port 43, an annular flange 57 around a rear edge of the cone 52, two opposite orifices 54 on a shank (not numbered) interconnecting the cone 52 and the intermediate section 51, a flow path 53 starting from the orifices 54 and terminating at a rear opening of the adjusting member 50, inner threads 55 on a rear portion of the flow path 53, the inner threads 55 being adapted to secure to a connector of a drain (not shown), and a hexagonal projection 56 on a rear end of the adjusting member 50.

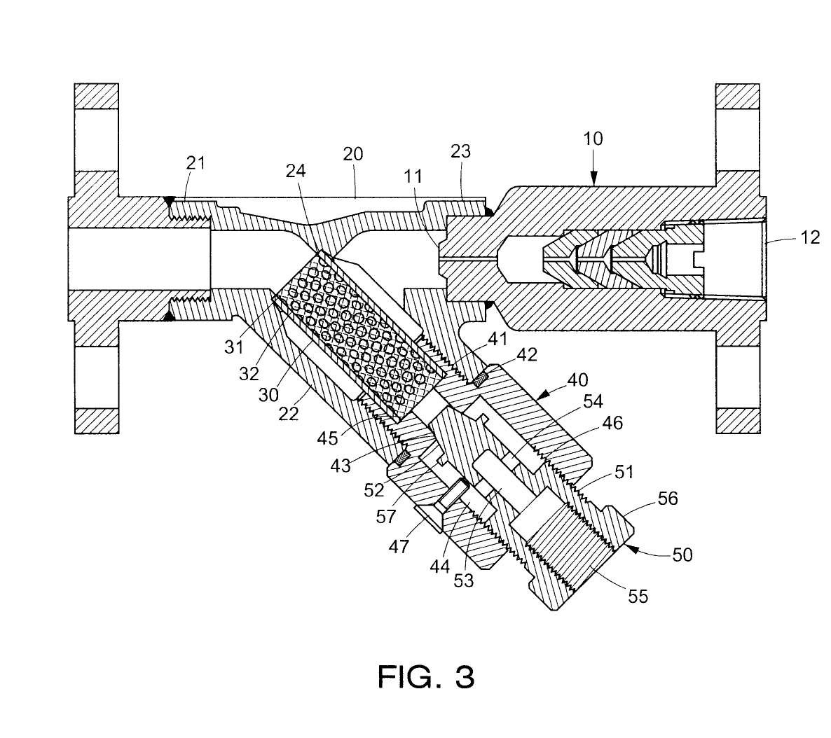

As shown in FIG. 3, a rear portion of the adjusting member 50 is exposed when the steam trap 10 is in an operating state. Also, the valve 40 is closed by inserting the cone 52 into the inlet port 43. In this position, steam passes the fibrous pad 31 to separate particulate matter. Next, the pure steam leaves the apertures 96 prior to entering the steam trap 10.

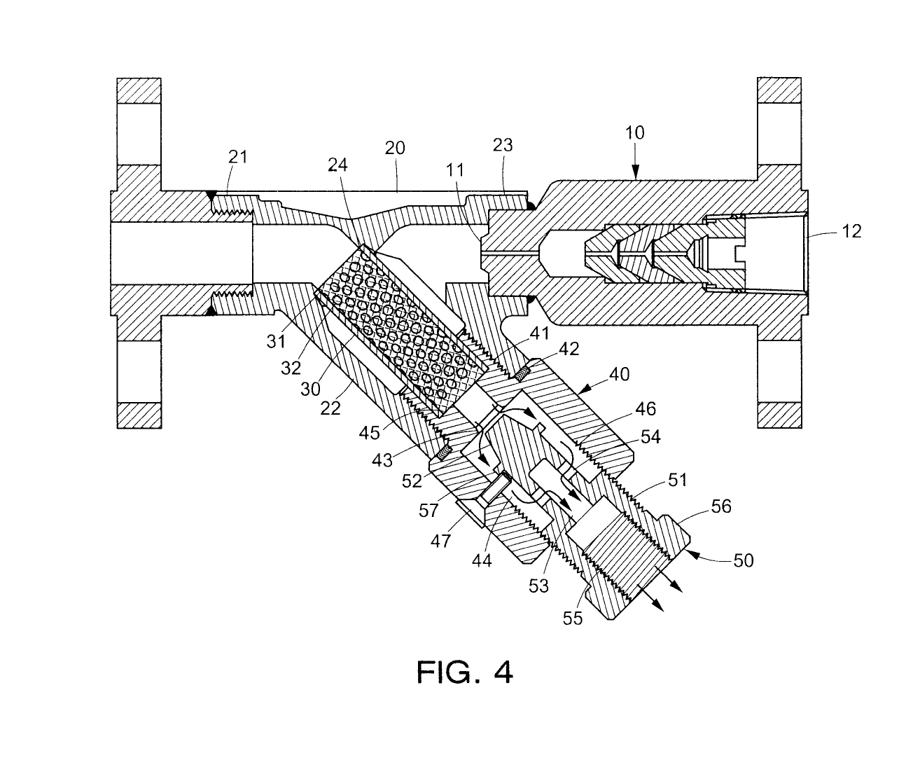

As shown in FIGS. 3 and 4, a cleaning operation of the filter 30 will be described in detail below. An employee may use a tool (e.g., wrench) to loosen the adjusting member 50 by turning the projection 56 counterclockwise. As such, the cone 52 disengages the inlet port 43. The steam thus can clean the filter 30 and carry the particulate matter to the drain via the chamber 44, the orifices 54, and the flow path 53 as indicated by arrows. The loosening of the adjusting member 50 is stopped when the flange 57 contacts the screw 47. This can prevent the adjusting member 50 from completely detaching from the valve 40 undesirably due to careless operation. Moreover, tolerance between the valve 40 and the adjusting member 50 is precisely controlled. As such, steam leaking is substantially avoided. In addition, the employee can detach the screw 47, the adjusting member 50, and the valve 40 prior to replacing the filter 30 with a new one.

The invention has the following advantages. Filter cleaning can be done without detaching any components while the boiler is operating. The cleaning is safe. Moreover, the cleaning is effective.

While the invention herein disclosed has been described by means of specific embodiments, numerous modifications and variations could be made thereto by those skilled in the art without departing from the scope and spirit of the invention set forth in the claims.

What is claimed is:

1. A steam trap comprising:
a condensate trapping member;
a Y-shaped body having a first end secured to the condensate trapping member, a second end secured to one end of a steam pipe, and an inclined projecting housing;
a filter disposed in the housing;
a valve sealingly secured to one end of the housing and lockingly secured to the filter, the valve comprising an inlet port having a flared inner end, a chamber in communication with the inlet port, inner threads on a rear portion of the chamber, and a releasable stop projecting into the chamber; and
an adjusting member comprising an intermediate threaded section adapted to secure to the inner threads, a forward cone adapted to insert into the inner end of the inlet port for closing the valve, an annular flange around a rear edge of the cone, a shank interconnecting the cone and the threaded section, at least one orifice on the shank, a rear space having inner threads secured to one end of a drain, a flow path starting from the at least one orifice and terminating at the space, and a rear enlargement,
whereby loosening the adjusting member by turning the projection in one direction until the flange is stopped by the stop will cause the cone to disengage the inlet port, thereby permitting steam conveying from the steam pipe to clean the filter and carry particulate matter to the drain via the chamber, the at least one orifice, the flow path, and the space.

2. The steam trap of claim 1, wherein the projection is hexagonal.

3. The steam trap of claim 1, wherein the stop is a screw.

4. The steam trap of claim 1, wherein the number of the at least one orifice is two.

5. The steam trap of claim 4, wherein the orifice are disposed oppositely.
